(19) United States
(12) Patent Application Publication
(10) Pub. No.: US 2022/0227099 A1
(43) Pub. Date: Jul. 21, 2022

(54) MULTIAXIAL TEXTILE FABRIC WITH DISCONTINUOUS INTERMEDIATE LAYER

(71) Applicant: TEIJIN CARBON EUROPE GMBH, Wuppertal (DE)

(72) Inventors: Johannes REHBEIN, Solingen (DE); Vera RICHTER, Düsseldorf (DE); Ronny WOCKATZ, Höchstadt (DE)

(73) Assignee: TEIJIN CARBON EUROPE GMBH, Wuppertal (DE)

(21) Appl. No.: 17/608,315

(22) PCT Filed: Apr. 28, 2020
(86) PCT No.: PCT/EP2020/061688

§ 371 Date: Nov. 2, 2021

Related U.S. Application Data
(60) Provisional application No. 62/845,402, filed on May 9, 2019.
(60) Provisional application No. 62/845,999, filed on May 10, 2019.

(30) Foreign Application Priority Data
Jun. 12, 2019 (EP) 19179663.0

(51) Int. Cl. B32B 5/26; B32B 3/18; B32B 5/02; B32B 5/08

(52) U.S. Cl. CPC B32B 5/265; B32B 3/18; B32B 5/022; B32B 5/028; B32B 5/08; B32B 2250/20; B32B 2605/18; B32B 2260/046; B32B 2262/106; B32B 2262/12; B32B 2305/08; B32B 2307/52; B32B 2260/021

(57) ABSTRACT

A multiaxial textile fabric has at least two thread layers and at least one nonwoven layer. Each thread layer is made of multifilament reinforcement yarns arranged parallel to one another and so as to lie adjacently next to one another within the thread layers, wherein at least one thread layer is at least partially directly contacted by the nonwoven layer, and cut-out sections are provided within the nonwoven layer, the cut-out sections having a size of at least 4 mm². The multiaxial textile fabric also includes a fiber-reinforced composite material.

The invention relates to a multiaxial non-crimp fabric with at least two thread layers, wherein the thread layers are formed by multifilament reinforcing yarns arranged parallel to one another and abutting on one another. At least one of the thread layers is in a physical contact with a non-woven layer.

Non-woven layers which are in contact with layers of reinforcing fiber yarns are generally known. For example, document U.S. Pat. No. 8,246,882 describes an intermediate layer of continuous fibers that can be placed between reinforcing fiber layers.

Document EP 2 636 783 discloses a composite material of at least two different layers. A first layer can be a layer of carbon fibers, wherein the carbon fibers can have a length of 20 to 100 mm and originate, for example, from a recycling process. A second layer is a random fiber layer, for example of thermoplastic fibers. Both layers are needled together.

Document DE 20 2004 007 601 describes a multiaxial non-crimp fabric with at least one thread system. A fiber non-woven can be part of the multiaxial non-crimp fabric and carbon fibers are mentioned as fibers for the reinforcing yarns.

In document WO 2011/113752, so-called hybrid non-woven layers are used.

A disadvantage of the known intermediate layers is that the intermediate layers usually increase the stiffness of the structure in which they are introduced. This makes it more difficult to drape the assembly of reinforcing fiber layers and intermediate layers within a shaping tool, for example. Furthermore, it is disadvantageous that during component manufacture from the multiaxial non-crimp fabrics, conductivity is often impeded due to the intermediate layers in the thickness direction of the component (Z-direction).

The object of the present invention is to overcome the disadvantages known so far from the prior art.

The object is solved by means of a multiaxial non-crimp fabric as described above which has a non-woven layer as an intermediate layer, wherein the non-woven has cutouts, wherein the cutouts have an area of at least 4 mm² and the non-woven layer is a discontinuous layer due to the cutouts.

The use of non-woven layers with cutouts in multiaxial non-crimp fabrics—as claimed in claim 1—has various advantages. For example, if the thread layers are formed from conductive fibers, the cutouts in the non-woven layer can provide direct contact with successive thread layers which, in other embodiments of the non-woven layer, would be separated due to the non-woven layer. Consequently, a conductivity in the Z-direction (parallel to the thickness extension) emerges, which can also be important for the later component (manufactured from the multiaxial non-crimp fabrics). This conductivity is relevant, for example, in aircraft construction for protection against damage caused by lightning. Furthermore, the non-woven layer with cutouts can facilitate a later matrix infusion as the matrix material can flow particularly well through the cutouts and distribute. In addition, via the choice of the number of cutouts or the positioning of the cutouts within the non-woven layer, the flow rate of the matrix material and also the distribution of the matrix material can be adjusted.

For example, a non-woven material with many (also larger) cutouts can be provided at places in the component that are poorly impregnated during matrix infusion in a normal process. Without changes in the infusion process, it is advantageously possible to adapt to difficult component configurations.

At least one of the fiber layers is in direct contact with the non-woven layer, wherein the fiber layer at least partially directly touches the non-woven layer. The direct contact can also be caused by a binding agent of the non-woven layer, which at least partially adheres or hangs to and/or on the at least one fiber layer.

In one embodiment, the at least one non-woven layer has more than 70% discontinuous fibers. That is, less than 30% of all fibers of the non-woven layer are continuous fibers. In one embodiment, almost all of the fibers of the at least one non-woven layer are discontinuous fibers. In another embodiment, the at least one non-woven layer has more than 70% continuous fibers. That is, less than 30% of all fibers of the non-woven layer are discontinuous fibers. In a particular embodiment, almost all of the fibers of the at least one non-woven layer are continuous fibers. The term “almost” in either case means more than 95% of the fibers. A fiber shall be considered continuous if its length is more than 500 mm. Preferably, the discontinuous fibers have a mean fiber length in the range of 8 to 500 mm, more preferably up to 300 mm. Mean fiber length means here that the discontinuous fibers have a length in the specified range which deviates by less than 15% from the specified range. The discontinuous fibers can be laid as discontinuous fibers and thus form the non-woven layer or can be laid as continuous fibers and only become discontinuous fibers with the corresponding length due to the cutouts within the non-woven layer.

A discontinuous surface according to the invention is formed by the non-woven layer if the non-woven layer is not formed as an approximately closed surface. A discontinuous non-woven layer is consequently a non-closed layer, wherein according to the invention the non-closedness is achieved at least due to the cutouts with an area of at least 4 mm². The non-woven layer can also form a discontinuous surface due to other reasons and still additionally be discontinuous due to the cutouts.

A discontinuous non-woven layer can also be formed due to the non-woven layer having slits. A slit is to be understood as an incision in the non-woven in which the non-woven layer is cut or the non-woven layer is divided by means of a cutting instrument. Upon such a cut into the non-woven layer, no material is removed from the non-woven layer or is displaced in such a way that a free area emerges within the non-woven layer with an area of more than 4 mm². A non-woven layer with slits is therefore not to be confused with a non-woven layer with cutouts. In the case of a non-woven layer with cutouts, material of the non-woven layer is removed or displaced from the non-woven layer, whereby free areas (cutouts, holes) are formed within the non-woven layer, which according to the invention are to have an area of at least 4 mm². In this case, cutouts are formed which are different from slits. A slit non-woven layer is not part of the invention and is consequently not claimed.

In one embodiment, the cutouts within a non-woven layer have same or different shapes and/or sizes. For example, the cutouts can have a round, oval, angular or random contour. The size and the area of the cutouts can vary randomly or selectively within the non-woven layer.

The minimum size of 4 mm² for the cutouts results from a contiguous area of the cutout.

Preferably, the non-woven layer has a thickness perpendicular to the longitudinal extension of the non-woven layer of about 70 μm, more preferably of about 40 μm, further preferably of about 50 μm and most preferably of about 25 μm. Due to the low thickness of the non-woven layer, the fiber volume fraction in the multiaxial non-crimp fabric and thus in the later component can be adjusted to a high level. By this, the mechanical properties, such as the breaking strength, of a component later made from the multiaxial non-crimp fabric can be improved. In addition, a thin non-woven layer with cutouts further improves the conductivity of a later component as the fiber layers can come into contact with one another more easily.

Due to the discontinuous non-woven layer, it can be advantageously achieved—as already described—that the thread layers of the multiaxial non-crimp fabric are at least partially in a direct contact with one another, thus touch one another, even if a non-woven layer is arranged in between. In this way, the conductivity of the multiaxial non-crimp fabric can be achieved or improved, for example in the thickness direction, provided that the thread layers of the multiaxial non-crimp fabric are conductive. An improvement of the conductivity in the thickness direction of the multiaxial non-crimp fabric has a particularly positive effect if the non-woven layer is both discontinuous and very thin (less than 40 μm thickness extension).

Preferably, the non-woven layer is formed by fibers which have a filament diameter of 3 to 50 μm, more preferably up to 35 μm. Due to sufficiently thin intermediate layers (non-woven layers), high fiber volume contents can advantageously be achieved in the multiaxial product.

Preferably, the width of the non-woven layer corresponds to the width of the thread layers. Preferably, the width of the non-woven layer is thus equal to the width of the multiaxial non-crimp fabric. Preferably, the width of the non-woven layer is 1.3 m, more preferably 3.3 m and most preferably 5 m and further most preferably 10 m.

Preferably, the multifilament reinforcing yarns are carbon fiber, glass fiber, or aramid yarns, or highly stretched UHMW polyethylene yarns. Mixtures of said fibers can also be used as multifilament reinforcing yarn.

Particularly preferred, the multifilament reinforcing yarns are carbon fiber yarns with a strength of at least 5000 MPa, measured according to JIS-R-7608, and a tensile modulus of at least 260 GPa, measured according to JIS-R-7608, and/or carbon fiber yarns with a strength of at least 4500 MPa, measured according to JIS-R-7608, and a tensile modulus of at least 240 GPa, measured according to JIS-R-7608.

In one embodiment, the non-woven layers additionally have said carbon fiber yarns. Preferably, the non-woven layers consist completely or partially of said carbon fibers (for example, in the form of a carbon fiber paper).

Preferably, the cutouts in the non-woven layer are regularly distributed. By a regular distribution it should be understood that the number of cutouts per area unit within the non-woven layer is approximately constant. Approximately constant includes a deviation in the range of about 5%. Particularly preferably, the cutouts within the non-woven layer are arranged in rows (cutout rows). The rows can preferably run perpendicularly, particularly preferably approximately transversely, to the laying direction of the fibers—which are to form the non-woven layer. In a preferred embodiment, the non-woven layer has a plurality of rows with cutouts, wherein the cutout rows run perpendicular to the laying direction of the fibers and the cutouts themselves have a longitudinal extension perpendicular to the laying direction of the fibers. Furthermore, it is preferred if all adjacent cutout rows have a same distance from one another. It is furthermore preferred if the cutouts of directly adjacent cutout rows have an offset from one another. In the case of such an offset, the cutouts of directly successive following cutout rows are not at the same height perpendicular to the longitudinal extension of the cutout rows, but have a difference in height (offset). Preferably, due to the offset a free section emerges between the cutouts of adjacent cutout rows. Within the free section, there is no interruption due to a cutout in the non-woven layer. Preferably, the offset alternates within the cutout rows, which means that, for example, the cutouts of a first and a third cutout row no longer have an offset from one another, but the cutouts of the second cutout row have a same offset from the cutouts of the first and third cutout rows. The alternation can lead to a same cutout position of the cutouts of each second cutout row—as in the example mentioned. However, other alternations are also possible, such as a same cutout position of the cutouts for every third or fourth cutout row.

The regular arrangement of cutouts within the non-woven layer is advantageous, as this makes the properties of the non-woven layer (and thus of the multiaxial non-crimp fabric) particularly well predictable and adaptable to the later component. For example, the drapeability of the non-woven layer is approximately the same at all points of the non-woven layer. Furthermore, the permeability of the non-woven layer is also approximately the same everywhere within the non-woven layer.

In a further preferred embodiment, the cutouts are irregularly distributed within the non-woven layer. Irregular in this context means that the number of cutouts per area unit varies. Irregular in this context also means that, for example, at least two regions are present within the non-woven layer, in that the cutouts are evenly distributed within the respective region, but the distribution in the at least two regions occurs in a different manner compared to one another. For example, a different cutout row (more cutouts, larger/longer cutout areas, varying cutout distance from one another within the cutout row, offset of the cutouts, cutout shape and/or distance between the cutout rows) can be present in a first region than in a second region. A non-woven layer with irregular cutouts can be particularly well adjusted to the later component. For example, the non-woven layer can have a greater number of identical cutouts in regions of strong contours of the later component than in regions of the later component with few contours. In this way, the drapability of the multiaxial non-crimp fabric can be positively influenced without impairing the manageability of the multiaxial non-crimp fabric due to an excessively unstable non-woven layer.

Both the regularly and the irregularly arranged cutouts can be longitudinal cutouts (with respect to the laying direction of the threads of the non-woven layer), transverse cutouts (with respect to the laying direction of the threads of the non-woven layer), star-shaped cutouts and/or cross cutouts.

In one embodiment, the cutouts in the non-woven layer are produced by punching and/or cutting out non-woven material. In another embodiment, the cutouts within the non-woven layer are produced by displacing the fibers of the non-woven layer within the non-woven layer so that a cutout emerges. In the latter case, therefore, no material is removed from the non-woven layer, but material from the non-woven layer is shifted within the non-woven layer. In such a case, also regions with an increased fraction of fiber material emerge within the non-woven layer. In any case, however, cutouts (free areas, holes) must emerge within the non-woven layer that have an area of at least 4 mm². Otherwise, it is not a cutout according to this invention. Possible areas for the cutouts range from 4 to 300 mm², for example between 10 to 100 mm², between 80 to 150 mm², and/or between 120 to 250 mm².

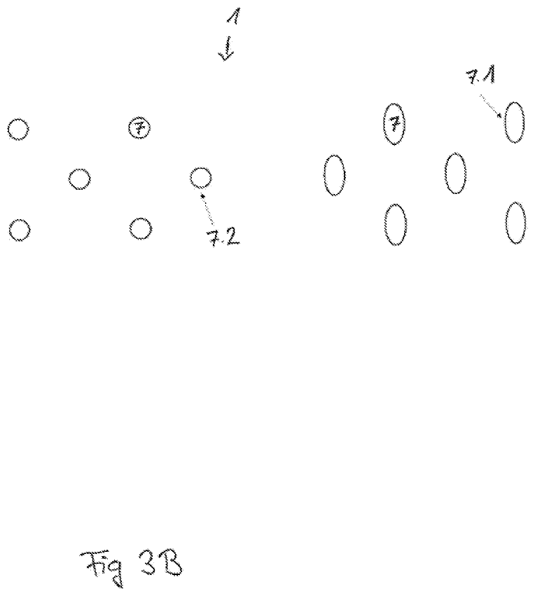

The cutouts can, for example, be circular or of elliptic shape (FIG. 3 B). Preferably, the area of these cutouts is up to 200 mm², more preferably up to 100 mm² and particularly preferably up to 10 mm². The distance between the cutouts is preferably approx. 100 mm, more preferably up to 50 mm and even more preferably up to 15 mm.

In one embodiment, the non-woven layer has a conductive material. The conductive material can be positioned as an extra layer on the non-woven layer or can be incorporated into or applied to the non-woven layer by means of powder, particles, fibers or droplets. Preferably, the non-woven layer has carbon fibers which are distributed approximately homogeneously within the non-woven layer. In a further embodiment, the non-woven layer has coated conductive fibers which are found on the non-woven layer (for example as an extra layer) and/or within the non-woven layer. Suitable as a coating material are, for example, copper, silver, nickel or other metals, as well as mixtures of said coating materials. In one embodiment, the cutouts can also be present in the extra layer. For example, after positioning the extra layer on the non-woven layer, the cutouts can be introduced (simultaneously or time-staggered) into the non-woven layer and the extra layer so that cutouts are formed at the same position within the non-woven layer and within the extra layer.

In one embodiment, the non-woven layer has a binder material. By means of the binder material, the fibers of the non-woven layer are stabilized and held together within the non-woven layer. For example, styrene acrylic resin and/or bisphenol-A and/or the like can be used as the binder material. Preferred particle sizes for the binders to be used are in a range of 50-160 μm, particularly preferably between 80-140 μm.

In a further embodiment, the non-woven layer has a polyester. Preferably, the fibers forming the non-woven layer consist of polyester. Particularly preferably, the non-woven layer consists of short fibers of polyester.

Preferably, the non-woven layer is manufactured by a wet-laid process. This achieves a closed and uniform surface quality prior to introduction of the cutouts. An additional binder application takes place either by direct admixture of the binder already during the non-woven manufacture or by separate subsequent application by a coating process to the surface. In other embodiments, the non-woven layer can also be manufactured by a spunlaced, spunlaid and/or needlepunch process. By the manufacturing processes just mentioned, more open structures with improved drape and permeability properties can be manufactured.

In all of the mentioned manufacturing processes of the non-woven layer, a binder can preferably be added, wherein the binder is introduced into the manufacturing process by an impregnation bath of the fibers of the non-woven layer, by an impregnation bath of the finished non-woven layer, and/or by sprinkling the formed non-woven layer with a binder powder with a preferred particle size in the range of 50-160 μm and subsequently slightly melting the binder powder for bonding with the fibers of the non-woven layer.

Regardless of the manufacturing process, the cutouts can be introduced into the non-woven after the non-woven is manufactured or can be produced within the non-woven layer during the manufacture of the non-woven layer. For example, a non-woven layer without cutouts can be drawn over a spine grid before the non-woven layer is consolidated so that cutouts with a contiguous area of at least 4 mm² are formed by displacement of fiber material within the non-woven layer. In the case of a cutout formation by displacement of the material of the non-woven layer, the area must have a continuous size of at least 4 mm². In another embodiment, for example, in the wet-laid process, the hole size of the screen can be varied during laying so that cutouts in the non-woven emerge.

In one embodiment of the invention, the non-woven layer has a thermoplastic polymeric material, wherein the thermoplastic polymeric material comprises a first polymeric component and a second polymeric component whose melting temperatures are below the melting or decomposition temperature of the multifilament reinforcement yarns, wherein the first polymeric component has a lower melting temperature than the second polymeric component and the first polymeric component is soluble in epoxy, cyanate ester, or benzoxazine matrix resins, or in mixtures of these matrix resins and the second polymeric component is not soluble in epoxy, cyanate ester, or benzoxazine matrix resins, or in mixtures of these matrix resins.

Preferably, the first polymeric component has a melting temperature in the range between 80 and 135° C. and the second polymeric component has a melting temperature in the range between 140 and 250° C.

Due to its specific structure, the multiaxial non-crimp fabric is characterized by good drapability and fixability of the thread layers in a preform, by a good permeability during infiltration with matrix resin, and by the fact that components with high mechanical strength and high impact strength can be manufactured with them. During component manufacture, the multiaxial non-crimp fabric with the at least one non-woven layer of the polymer combinations mentioned is brought into the desired shape and heated above the melting temperature of the first polymeric component. During cooling of the preform, the first polymeric component then acts as a melt adhesive and fixes the thread layers in position.

During the subsequent infiltration of the multiaxial non-crimp fabric, wherein preferably a plurality of multiaxial non-crimp fabrics forms a non-crimp structure (layer structure), with matrix resin, which usually occurs at temperatures above the melting temperature of the first component but below the melting temperature of the second component, the higher-melting second polymeric component of the non-woven layer also ensures good permeability for the matrix resin. The first polymeric component, on the other hand, dissolves in the matrix resin and thus loses its identity as an independent phase in relation to the matrix resin. Therefore, the fraction of the first polymeric component is thus attributable to the matrix material and the fraction of matrix resin to be infiltrated can be reduced by the fraction of the first polymeric component. As a result, high fiber volume fractions of the multifilament reinforcing yarns can be adjusted in the resulting component and thus the level of the mechanical strength characteristic values can be retained at a high level.

The non-woven layer employed in the multiaxial non-crimp fabric can consist of a mixture of monocomponent fibers with different melting temperatures, thus it can be a hybrid non-woven. However, the non-woven layer can also consist of bicomponent fibers, for example core-sheath fibers, wherein the core of the fiber is composed of a higher melting polymer and the sheath of a lower melting polymer. Preferably, the non-woven layer is a hybrid non-woven. It has been found to be advantageous if the non-woven layer comprises the first polymeric component in a fraction of 20 to 40 wt. % and the second polymeric component in a fraction of 60 to 80 wt. %.

At the curing temperature of the matrix resin, i.e. the epoxy, cyanate ester, or benzoxazine resin, in a preferred embodiment the first polymeric component reacts chemically with the curing matrix resin via crosslinking reactions and thus becomes an integral part of a homogeneous matrix. Therefore, the first polymeric component is preferably a polymer that reacts with epoxy, cyanate ester, or benzoxazine matrix resins via chemical crosslinking reactions. Particularly preferably, the first polymeric component is a polyhydroxyether. Such polyhydroxyethers are described, e.g., in EP 1 705 269, the disclosure of which in this regard is expressly referred to.

Preferably, the second polymeric component has a higher melting temperature than the first polymeric component. Preferably, the second polymeric component melts at the curing temperature of the employed matrix resin or at temperatures in the range between the melting temperature of the first polymeric component and the curing temperature of the matrix resin. In this way, the second polymeric component is also incorporated into the matrix material, but unlike the first polymeric component, it forms its own phase in the cured matrix resin. This phase formed by the second polymeric component helps to limit, during curing and in the later component, the propagation of cracks and thus contributes decisively, e.g., to increasing the impact strength.

As the second polymeric component of the non-woven layer, common polymers that can be processed into thermoplastic filaments can be employed, as long as they meet the conditions according to the claim, such as e.g. polyamides, polyimides, polyamide imides, polyesters, polybutadienes, polyurethanes, polypropylenes, polyetherimides, polysulfones, polyether sulfones, polyphenylene sulfones, polyphenylene sulphides, polyether ketones, polyetheretherketones, polyarylamides, polyketones, polyphtalamides, polyphenylene ethers, polybutylene terephthalates or polyethylene terephthalates or copolymers or mixtures of these polymers.

With regard to the aforementioned matrix resins, it is preferred if the second polymeric component is a polyamide homopolymer or polyamide copolymer or a mixture of polyamide homopolymers and/or polyamide copolymers. Particularly preferably, the polyamide homopolymer or copolymer is a polyamide 6, polyamide 6.6, polyamide 6.12, polyamide 4.6, polyamide 1 1, polyamide 12, or polyamide 6/12.

With regard to creating a uniformity of the material properties over the thickness of the multiaxial non-crimp fabric, it is advantageous if a non-woven layer is arranged between each thread layer of multifilament reinforcing yarns in the multiaxial non-crimp fabric. With regard to the properties of the component manufactured with the multiaxial non-crimp fabric and with regard to an as high as possible characteristic value level of the mechanical properties, it is also preferred if the non-woven layer has a weight per area in the range of 3 and 25 g/m². Particularly preferably, the weight per area is in the range of 4 and 10 g/m².

A further subject matter of the invention is a layer structure for manufacturing a fiber-reinforced composite material with at least one multiaxial non-crimp fabric, as previously described. The layer structure with the at least one multiaxial layer can be a preform or a fiber-reinforced component, if an additional matrix material has been introduced into the layer structure.

The invention is explained in more detail on the basis of figures.

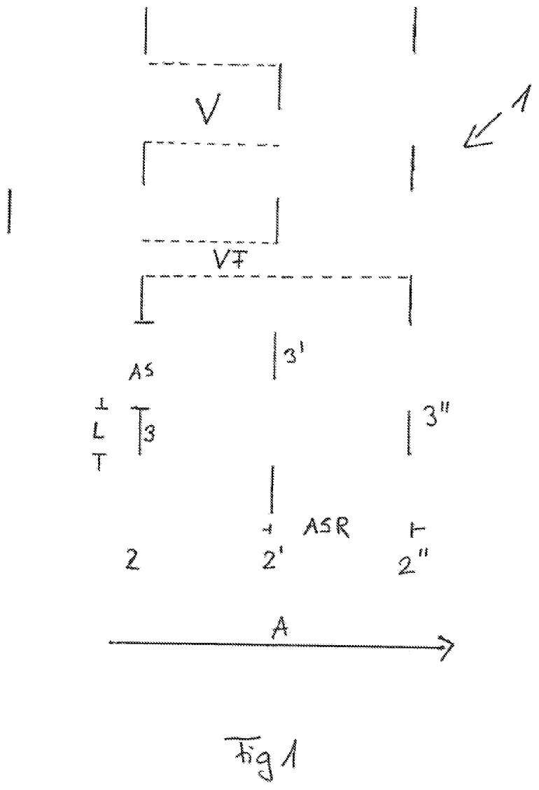

FIG. 1 schematically shows an embodiment of a non-woven layer with slits, which is not according to the invention.

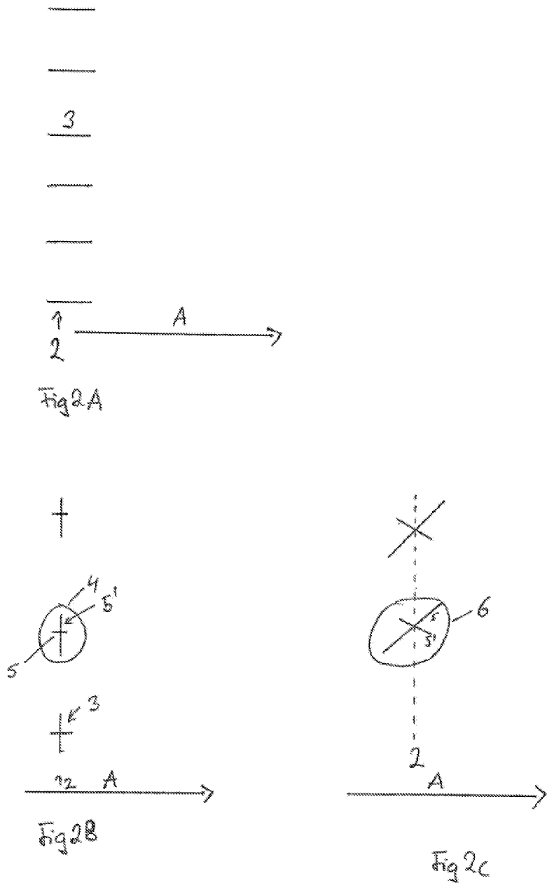

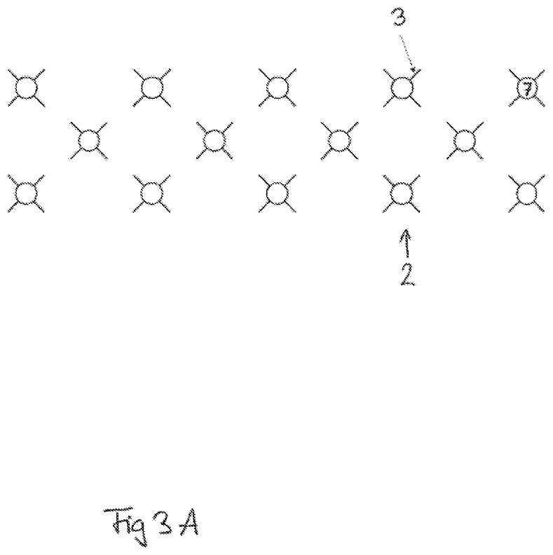

FIG. 2 schematically shows various slit forms which are also not according to the invention.

FIG. 3 A and B schematically show an embodiment of a non-woven layer with cutouts.

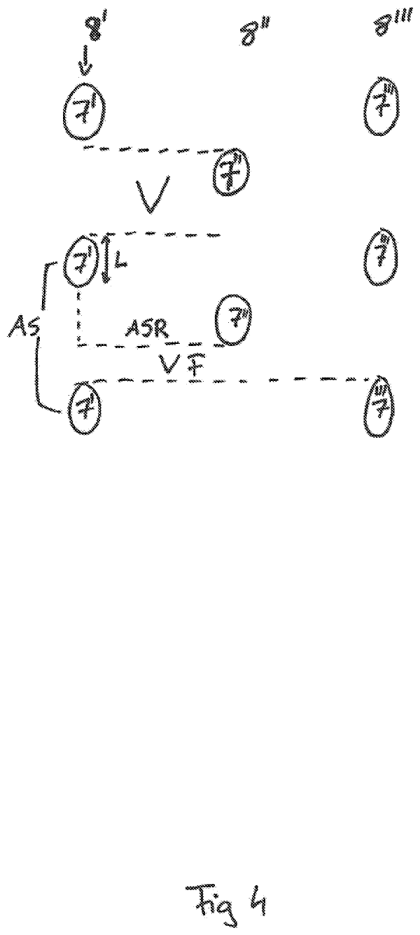

FIG. 4 schematically shows a non-woven layer with cutout rows.

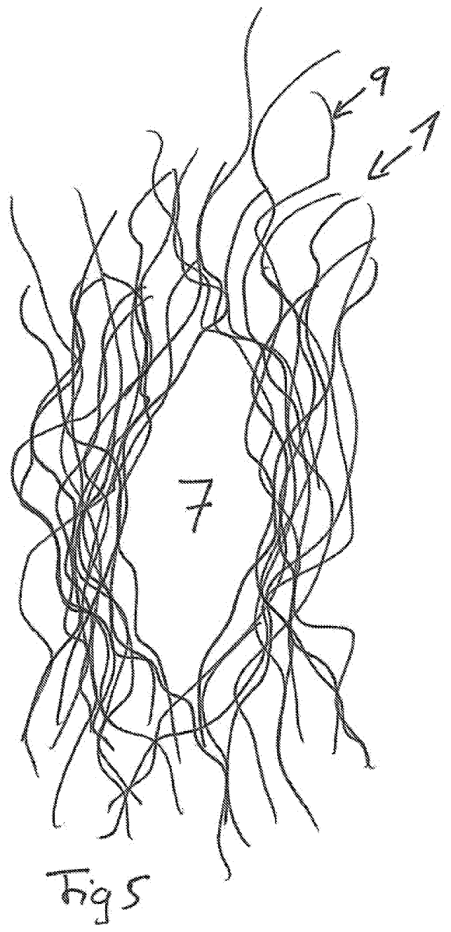

FIG. 5 schematically shows a non-woven layer with a cutout which has emerged due to material displacement.

FIG. 1 shows an embodiment not according to the invention with slits in the non-woven layer 1. FIG. 1 schematically shows a portion of a slit pattern of a non-woven layer 1. The non-woven layer 1 has slit rows 2 with slits 3 approximately perpendicular to the laying direction A of the fibers. In the figure, the slits 3 are formed as longitudinal slits, wherein their longitudinal extension extends parallel to the longitudinal extension of the slit row 2. Within a slit row 2, the slits 3 have a distance AS from one another. The slit rows 2 have a distance ASR from one another. Adjacent slit rows 2″, 2′ can have slits 3′, 3″ which have an offset V from one another. In FIG. 1, the offset V is provided alternately for every second slit row 2 so that the position of the slits 3 of one slit row 2 and a next but one slit row 2″′ are at the same height perpendicular to the longitudinal extension of the slit rows 2. In FIG. 1, the slits 3 have a length L. Due to the offset V of the slits 3, 3′ and 3″, a free section VF results. If the discontinuous fibers are first formed due to the slits 3 in the non-woven layer 1, the fibers of the non-woven layer 1 can at most run over the section VF before they are separated due to a slit 3. It is understood that the length of the discontinuous fiber of the non-woven layer 1 can be longer than VF, as the fiber within the non-woven layer can be present corrugated/curved.

FIG. 2 also shows an embodiment not according to the invention. FIG. 2 schematically shows different shapes of the slits 3. In FIG. 2 A, the slits 3 are transverse slits whose longitudinal extension is substantially perpendicular to the longitudinal extension of the slit row 2. In FIG. 2 B the slits 2 have a cross shape 4 with two incisions 5 5′, wherein one incision 5′ runs parallel to the longitudinal extension of the slit row 2. In FIG. 2 C the slits 3 are configured in a star shape 6, the star shape 6 having at least two incisions 5, 5′. In the case of two incisions 5, 5′ in star shape 6, none of the incisions 5, 5′ is arranged parallel or perpendicular to the longitudinal extension of the slit row 2. In general, the star shape 6 consequently differs from the cross shape 4 in that it has at least one incision 5 arranged at an angle to the longitudinal extension of the slit rows 2.

Different shapes of slits 3 can be present within a non-woven layer 1. The different slit shapes can also be present within a slit row 2.

In FIG. 3 A, a non-woven layer with cutouts 7 in combination with slits in star shape is schematically depicted. The cutouts 7 have emerged, for example, by material being punched out of the non-woven layer 1.

In FIG. 3 B, two possible types of cutouts 7 for the non-woven layer 1 are depicted. The cutouts 7 can be oval 7.1 or round 7.2, wherein a single type of cutout 7 or a mixture of different types of cutouts 7 can be present within the non-woven layer 1. However, all cutouts 7 of this type have in common that material has been removed from the non-woven layer 1.

FIG. 4 schematically shows cutout rows 8 with cutouts 7. Within a cutout row 8, the cutouts 7 have a distance AS from one another. The cutout rows 8 have a distance ASR from one another. Adjacent cutout rows 8′, 8″ can have cutouts 7′, 7 which have an offset V from one another. In the embodiment example in FIG. 4, the offset V is provided alternately for every second cutout row 2 so that the position of the cutouts 7 of a cutout row 8 and a next but one cutout row 8″′ are at the same height perpendicular to the longitudinal extension of the cutout row 8. In FIG. 4, the cutouts 7 have a length L. Due to the offset V of the cutouts 7′, 7″ and 7″′, a free section VF results. If the discontinuous fibers are first formed due to the cutouts 7 in the non-woven layer 1, the fibers of the non-woven layer 1 can at most run over the section VF before they are separated due to a cutout 7. It is understood that the length of the discontinuous fibers of the non-woven layer 1 can be longer than VF, as the fibers within the non-woven layer can be corrugated/curved.

FIG. 5 schematically shows a detailed portion of a non-woven layer 1 with cutout 7, in which the cutout 7 is formed by displacement of fiber material within the non-woven layer 1. In the embodiment example, the fibers 9 within the non-woven layer 1 are deflected (shifted) such that an opening or hole emerges within the non-woven layer 1 so that a cutout 7 is formed. The cutout 7 is to have a size of at least 4 mm², which means that the hole or opening is to have a contiguous area of at least 4 mm². A contiguous area is given if the cutout 7 is not interrupted by non-woven material such as a plurality of fibers.

1. A multiaxial non-crimp fabric with at least two thread layers and at least one non-woven layer, wherein each thread layer is formed by multifilament reinforcing yarns arranged parallel to one another and next to one another abutting on one another within the thread layers, wherein at least one thread layer at least partially directly touches with the non-woven layer, wherein cutouts are provided within the non-woven layer, wherein the cutouts have an area of at least 4 mm² and the non-woven layer is a discontinuous layer at least due to the cutouts.

2. The multiaxial non-crimp fabric according to claim 1, wherein the cutouts are arranged regularly or randomly irregularly in the non-woven layer.

3. The multiaxial non-crimp fabric according to claim 1, wherein the cutouts have same or different shapes and/or sizes.

4. The multiaxial non-crimp fabric according to claim 1, wherein the non-woven layer has a conductive material, wherein the conductive material is applied to and introduced in the non-woven layer by means of powder and/or particles and/or the non-woven layer has conductive fibers.

5. The multiaxial non-crimp fabric according to claim 1, wherein the non-woven layer has a binder which has a particle size of 50-160 μm and/or the non-woven layer has a thickness which is less than 40 μm.

6. The multiaxial non-crimp fabric according to claim 1, wherein the non-woven layer has 70% continuous fibers with a fiber length of more than 20 m and/or the non-woven layer has 70% short fibers with a fiber length in the range of 8 to 15 mm.

7. The multiaxial non-crimp fabric according to claim 1, wherein the multifilament reinforcing yarns are carbon yarns with a strength of at least 5000 MPa, measured according to JIS-R-7608, and a tensile modulus of at least 260 GPa, measured according to JIS-R-7608, and/or carbon fiber yarns with a strength of at least 4500 MPa, measured according to JIS-R-7608, and a tensile modulus of at least 240 GPa, measured according to JIS-R-7608.

8. The multiaxial non-crimp fabric according to claim 1, wherein the non-woven layer has a polyester.

9. The multiaxial non-crimp fabric according to claim 1, wherein the non-woven layer has a thermoplastic polymeric material, wherein the thermoplastic polymeric material comprises a first polymeric component and a second polymeric component whose melting temperatures are below the melting or decomposition temperature of the multifilament reinforcing yarns, wherein the first polymeric component has a lower melting temperature than the second polymeric component and the first polymeric component is soluble in epoxy, cyanate ester, or benzoxazine matrix resins, or in mixtures of these matrix resins and the second polymeric component is not soluble in epoxy, cyanate ester, or benzoxazine matrix resins, or in mixtures of these matrix resins.

10. The multiaxial non-crimp fabric according to claim 9, wherein the first polymeric component has a melting temperature in the range between 80 and 135° C. and the second polymeric component has a melting temperature in the range between 140 and 250° C.

11. The multiaxial non-crimp fabric according to claim 9, wherein the second polymeric component is a polyamide homopolymer or polyamide copolymer or a mixture of polyamide homopolymers and/or polyamide copolymers.

12. The multiaxial non-crimp fabric according to claim 11, wherein the polyamide homopolymer or copolymer is a polyamide 6, polyamide 6.6, polyamide 6.12, polyamide 4.6, polyamide 11, polyamide 12, or polyamide 6/12.

13. The multiaxial non-crimp fabric according to claim 9, wherein the first polymeric component is a polymer that chemically reacts with epoxy, cyanate ester, or benzoxazine matrix resins upon crosslinking of these matrix resins.

14. The multiaxial non-crimp fabric according to claim 9, wherein the first polymeric component is a polyhydroxyether.

15. The multiaxial non-crimp fabric according to claim 9, wherein the non-woven layer contains the first polymeric component in a fraction of 20 to 40 wt. % and the second polymeric component in a fraction of 60 to 80 wt. %.

16. A layer structure, wherein the layer structure has at least one multiaxial non-crimp fabric according to claim 1.

17. A fiber reinforced composite material, wherein the composite material is formed from at least one layer structure according to claim 16 and a further matrix material.
